(19) United States
(12) Patent Application Publication
(10) Pub. No.: US 2013/0215079 A1
(43) Pub. Date: Aug. 22, 2013

(54) USER INTERFACE WITH HAPTIC FEEDBACK

(71) Applicants: Mark Thomas Johnson, Arendonk (BE); Bartel Marnus Van De Sluis, Eindhoven (NL); Dirk Brokken, Nuenen (NL)

(72) Inventors: Mark Thomas Johnson, Arendonk (BE); Bartel Marnus Van De Sluis, Eindhoven (NL); Dirk Brokken, Nuenen (NL)

(73) Assignee: KONINKLIJKE PHILIPS ELECTRONICS N.V., EINDHOVEN (NL)

(21) Appl. No.: 13/879,420

(22) PCT Filed: Nov. 3, 2011
(86) PCT No.: PCT/IB11/54882

§ 371 Date: Apr. 15, 2013

(30) Foreign Application Priority Data
Nov. 9, 2010 (EP) 10190542.0

(51) Int. Cl. G06F 3/01

(52) U.S. Cl. CPC G06F 3/016
USPC 345/174

(57) ABSTRACT

The invention relates to a user interface (100) comprising a touchable interaction surface (S) with an array (120) of actuators for providing haptic feedback. Moreover, the user interface comprises a controller (130) for controlling actuators in a coordinated manner such that they provide a directional haptic sensation. By means of this directional haptic sensation, a user touching the interaction surface (S) can be provided with additional information, for example about a given location on the interaction surface (S), or with a haptic feedback that corresponds to the movement of an image displayed on the interaction surface (S).

### FIELD OF THE INVENTION

The invention relates to a user interface with actuators for providing haptic feedback. Moreover, it relates to an apparatus comprising such a user interface and to a method for providing haptic feedback.

### BACKGROUND OF THE INVENTION

The US 2010/0231508 A1 discloses a device (e.g. a mobile phone) that comprises actuators for providing haptic feedback to a user. Thus a display of the device can for example be provided with a haptic appearance that resembles the real texture of an object depicted on said display.

### SUMMARY OF THE INVENTION

Based on this background it was an object of the present invention to provide means for further improving the interaction between a user and a device.

This object is achieved by a user interface according to claim 1, a method according to claim 2, and an apparatus according to claim 15. Preferred embodiments are disclosed in the dependent claims.

According to its first aspect, the invention relates to a user interface, i.e. to a device that mediates an interaction between humans and a machine. For example, a user interface may allow a user to input information and/or commands to an apparatus, or an apparatus may output information via a user interface. The user interface according to the invention shall comprise the following components:

a) A surface that can be touched by a user and via which an interaction between the user and the user interface takes place. For this reason, said surface will in the following be called “interaction surface”. The interaction surface may in general be touched in any arbitrary way, for example with the help of an instrument operated by a user. Most preferably, the interaction surface is adapted to be touched by one or more fingers of a user.
b) An array of actuators that is disposed in the aforementioned interaction surface for providing haptic feedback to a user. The term “actuator” shall as usual denote an element, unit, or device that can actively and mechanically interact with its environment, for example via a movement (e.g. shifting, bending, shrinking, expanding etc.) and/or by executing a force. Actuators in the context of the present invention will typically be small, occupying for example an area of less than about 10×10 mm², preferably less than about 1 mm² in the interaction surface. Moreover, the term “array” shall in general denote any regular or irregular spatial arrangement of elements. In the context of the present invention, the array will typically comprise a regular one- or two-dimensional arrangement of actuators, for example a matrix arrangement.
c) A controller that is capable of activating (all or at least a part of the) actuators in a coordinated manner such that they generate a directional haptic sensation to a user touching them. The controller may for example be realized in dedicated electronic hardware, digital data processing hardware with associated software, or a mixture of both.

By definition, a “directional haptic sensation” shall be a haptic sensation from which persons can derive a spatial direction (averaging over a plurality of persons can make the definition of said direction objective). The direction felt by a (representative) person will usually be generated by some anisotropic activity of the actuators, for example a coordinated movement in said direction. In everyday life, a “directional haptic sensation” is typically generated by a relative movement between an object and a person touching it (e.g. when the person touches a rotating disk). An array of actuators that remain fixed in place with respect to a user touching them may generate a directional haptic sensation for example by shifting the contact point between the user and the array, such that the movement of the contact point feels to the user like the movement of an (imaginary) object.

According to a second aspect, the invention relates to a method for providing haptic feedback to a user touching an interaction surface that is equipped with an array of actuators. The method comprises the coordinated activation of actuators of said array such that they generate a directional haptic sensation.

The method comprises in general form the steps that can be executed with a user interface of the kind described above. Reference is therefore made to the above description for more information on the details of this method.

The user interface and the method described above have the advantage that an array of actuators in an interaction surface is used to generate a directional haptic sensation. As will be explained in more detail with reference to preferred embodiments of the invention, such a directional feedback can favorably be used to provide additional information to a user when she or he interacts with a user interface and/or to provide a user with a more realistic/natural feedback.

The preferred embodiments of the invention that will be described in the following are applicable to both the user interface and the method described above.

According to a first preferred embodiment, the interaction surface is adapted to determine the position and/or a possible movement of at least one touch point at which it is touched by a user. This determination may be achieved by any appropriate means, for example with the help of buttons that are mechanically pressed. Most preferably, the determination is done without moving mechanical components according to the various principles and technologies that are known from touch screens or touch pads. These methods comprise for example resistive, capacitive, acoustic or optical measurements by which the position of a touch point can be determined.

The determination of a touch point and/or of its movement may be used to input information. For example, the position of the touch point may correspond to a certain character, symbol, or command (as on a keyboard). Or the movement of a touch point may be used to initiate a corresponding movement of some displayed image, of a (virtual) slide control, of a scrolling operation in a menu etc.

According to a further development of the first preferred embodiment, only actuators located in a region that depends on the position and/or on the movement of the at least one touch point are activated to provide a directional haptic sensation. Typically not all actuators of the whole array of actuators will be needed (and capable) to provide haptic feedback to a user, but only those that are currently contacted by the user. This group of relevant actuators can be determined in dependence on the position of the at least one touch point. A possible movement of a current touch point can be used to forecast the region on the interaction surface that will be touched next, allowing to optimally track the touch point(s) with the region(s) of activated actuators.

According to another development of the first preferred embodiment, the direction of the directional haptic sensation depends on the position and/or the possible movement of the at least one touch point. When a movement of the touch point is for example used to shift an image displayed on the interaction surface, the directional haptic sensation may be such that it simulates the friction a real object would generate when being accordingly shifted.

In another embodiment of the invention, the directional haptic sensation is directed to a given location on the interaction surface. The given location may be constant or optionally be dependent on some internal state of the user interface or of an associated apparatus.

For example, the aforementioned “given location” may correspond to the stationary position of some (virtual) key or control knob on the interaction surface. When a user touches the interaction surface outside this position, the directional haptic sensation may guide the user to the key or control knob. In another example, directional haptic sensation may be used to indicate the direction into which some (virtual) control knob or slider has to be turned or moved in order to achieve a desired result, e.g. in order to decrease the volume of a music player. An exemplary case of a time-variable “given location” is the last set position of a (virtual) slide control, for example in a volume control of a music player, the light intensity of a dimmable lamp etc. The described procedures of user guidance are particularly helpful when a user operates a user interface blindly.

In another embodiment of the invention, the directional haptic sensation is directed radially inward or radially outward with respect to some given centre, for example with respect to the centre of the interaction surface or with respect to the touch point at which a user touches the interaction surface. Such radial haptic sensation may particularly be used to indicate operations that are related to a shrinkage or an expansion of some object, and can also be used to suggest (virtual) out-of-plane interactions.

The interaction surface may preferably be located above some image display for dynamically representing pictures, graphics, text or the like. The display may be used to provide additional visual information to a user, to statically or dynamically display control buttons, keys, sliders, wheels etc., to provide visual feedback about input operations or the like.

According to a further development of the aforementioned embodiment, the directional haptic sensation generated by the actuators is correlated to an image and/or an image sequence that is/are shown on the display. If an image depicts for example a button at some position on the interaction surface, the direction of the haptic sensation may be oriented towards this position. In another example, an image sequence may show the movement of some (imaginary) object across the interaction surface, and the directional haptic sensation may correspond to the frictional sensation a real object moving that way would convey. In yet another example, the directional haptic sensation could guide the user to preferential presets, or towards a setting that the system recommends to be most relevant at the current situation.

In another development of the embodiment with a display, the directional haptic sensation is correlated to an expansion or contraction of a displayed image. In this way the zooming in or zooming out of an image can for instance be accompanied by a corresponding realistic (frictional) sensation. When a user initiates such a zooming in or zooming out for example by a coordinated movement of two or more fingers, the direction conveyed by the haptic sensation to these fingers may correspond to the forces occurring when a real object would be stretched (zooming in) or compressed (zooming out) accordingly.

The actuators that generate the directional haptic sensation may be realized by any appropriate technology. Most preferably, the actuators may comprise an electroactive material in which configuration changes can be induced by an electrical field. An especially important example of such materials are electroactive polymers (EAPs), preferably of a dielectric electroactive polymer which changes its geometrical shape in an external electrical field. Examples of EAPs may be found in literature (e.g. Bar-Cohen, Y.: “Electroactive polymers as artificial muscles: reality, potential and challenges”, SPIE Press, 2004; Koo, I. M., et al: “Development of Soft-Actuator-Based Wearable Tactile Display”, IEEE Transactions on Robotics, 2008, 24(3): p. 549-558; Prahlad, H., et al.: “Programmable surface deformation: thickness-mode electroactive polymer actuators and their applications”, in “Dielectric Elastomers as Electromechanical Transducers; Fundamentals, materials, devices, models and applications of an emerging electroactive polymer technology”, F. Carpi, et al, Editors. 2008, Elsevier, p. 227-238; US-2008 0289952 A; all the documents are incorporated into the present application by reference).

A directional haptic sensation may optionally also be generated by a graded activation of actuators. A graded activation requires that there are at least three degrees or states of activity of the respective actuators (i.e. not only on/off states), and that these degrees/states are used to generate a directional haptic sensation. The degree of activation may for example change (increase or decrease) monotonously in one direction, thus marking this direction. If the degree of activation correlates for example with the out-of-plane height to which an activator rises, the graded activation can be used to create a region on the interaction surface that is slanted in a given direction. In general, using different degrees of activation has the advantage that directional information can be represented with a static activation pattern.

According to another embodiment of the invention, actuators may be activated to change (adjust) the friction between an object touching the interaction surface and said interaction surface. Activation of actuators may for example generate an additional resistance against the movement of an object touching the interaction surface. If the generated friction is anisotropic, it can be used to convey a directional haptic sensation, distinguishing for example one direction via a minimal friction against relative movement. A resistance or friction may for instance be generated or modulated by changing the smoothness of the interaction surface.

An optional way to generate an anisotropic friction comprises the realization of patterns on the interaction surface that cause different surface roughnesses in different directions. A pattern of parallel lines may for example show a high friction in orthogonal and a low friction in axial direction. Another optional way to generate an anisotropic friction may comprise a transition between two areas of different roughness that is realized at a touching point. A moving finger will then experience a higher or a lower roughness (and the resulting different friction) depending on the direction of its movement.

The invention further relates to an apparatus comprising a user interface of the kind described above. This apparatus may particularly be a mobile phone, a remote control, a game console, or a light controller with which the intensity and/or color of lamps can be controlled.

### BRIEF DESCRIPTION OF THE DRAWINGS

These and other aspects of the invention will be apparent from and elucidated with reference to the embodiment(s) described hereinafter. These embodiments will be described by way of example with the help of the accompanying drawings in which:

FIG. 1 shows a schematic cross section through a user interface according to the present invention;

FIG. 2 illustrates the generation of a directional haptic sensation at a particular location;

FIG. 3 illustrates the generation of a directional haptic sensation by a moving activity pattern at a touch point and directed towards a given location;

FIG. 4 illustrates the generation of a directional haptic sensation by a graded activation of actuators;

FIG. 5 illustrates the generation of a directional haptic sensation by frictional feedback;

FIG. 6 illustrates the generation of a directional haptic sensation at two touch points;

FIG. 7 illustrates a radially inward haptic sensation on an actuator array;

FIG. 8 shows a top view onto a one-dimensional array of EAP actuators;

FIG. 9 shows a top view onto a two-dimensional array of EAP actuators.

Like reference numbers or numbers differing by integer multiples of 100 refer in the Figures to identical or similar components.

### DESCRIPTION OF PREFERRED EMBODIMENTS

One of the key requirements of reconfigurable user interfaces (UI) on display-based UI devices is the ability to navigate the fingers correctly and accurately across an interaction surface. In addition, the introduction of multi-fingered UI paradigms (e.g. zoom and stretch features) makes accurate user interaction increasingly challenging.

From user studies it is known that many people have a decreased level of “feeling in control” when operating touch-sensitive UI elements or touch screens due to the lack of tactile feedback given. This lack of “feeling in control” has been shown to result in more user errors during operation. Moreover, touch screens cannot be operated without looking at them, which is a drawback since many user interfaces (lighting controls, mobile media players, TV remote controls etc.) are preferably operated blindly.

In view of the above considerations, a haptics user interface is proposed featuring a (finger) guiding and stretching feature. The haptics surface may for example be configured to create a dynamically adjustable surface profile in the form of a “small hill”, which propagates over the (2D) surface like a wave. The propagating wave is used to either guide a finger to a point on the surface, stretch multiple fingers across a surface, or alternatively provide a “frictional resistance” to the movement of a finger across the surface. Two or more propagating waves moving away from the finger's position can be used to create the sensation of “falling in” or “zooming in” on an area or going one level deeper (e.g. when navigating a hierarchical menu or folder structure, or when a slider controlling a particular parameter in the user interface switches to fine-tuning mode). Likewise waves moving towards the finger can be used to create the opposite effect, creating the feeling of going up or back, or zooming out.

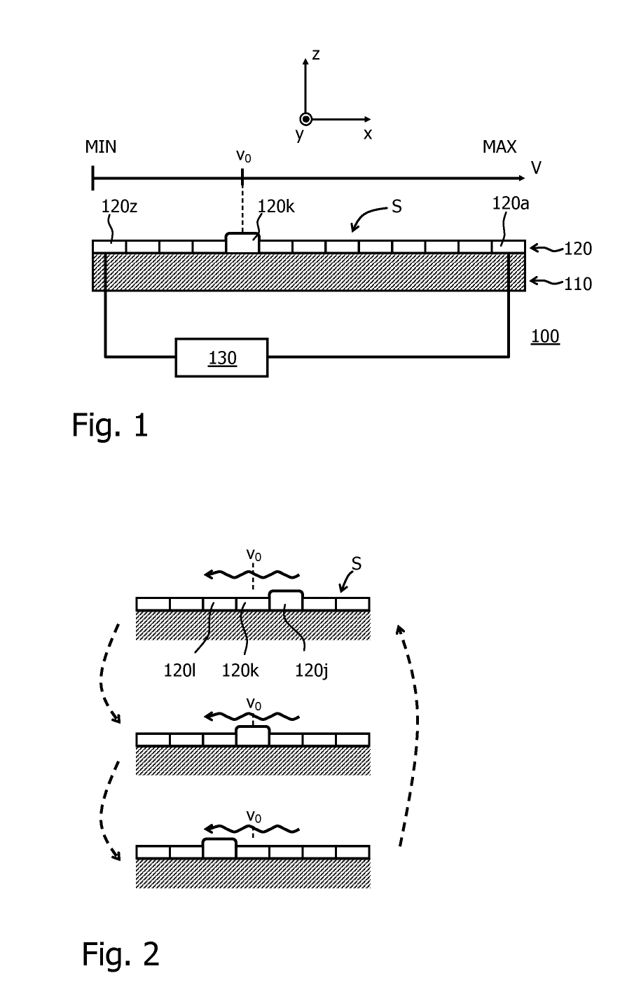

FIG. 1 shows schematically a sectional view of a user interface 100 that is designed according to the above general principles. The user interface 100 comprises a carrier or substrate 110 that may particularly be or comprise an image display (e.g. an LCD, (O)LED display etc.). The substrate/display 110 carries on its topside an array 120 of individual actuators 120a, . . . 120k, . . . 120z that extends in (at least) one direction (x-direction according to the shown coordinate system). The array 120 constitutes an interaction surface S that can be touched by a user with her or his fingers.

The actuators of the array 120 may particularly be or comprise an electroactive polymer (EAP), preferably a dielectric electroactive polymer which changes its geometrical shape in an external electrical field (also known as “artificial muscles”). These actuators allow surface morphing from a stack of polymer layers that is structured in the right way by direct electrical stimulation. Different actuator setups have been suggested to do this resulting in movement upward (Koo, Jung et al, Development of soft-actuator-based wearable tactile display, IEEE Trans. Robotics, vol. 24, no. 3 (June 2008), pp. 549-558), or downward (Prahlad, H., et al.: “Programmable surface deformation: thickness-mode electroactive polymer actuators and their applications”, in “Dielectric Elastomers as Electromechanical Transducers; Fundamentals, materials, devices, models and applications of an emerging electroactive polymer technology”, F. Carpi, et al, Editors. 2008, Elsevier, p. 227-238). This provides a very large freedom in shapes to be actuated, as the patterned electrode determines which part of a surface moves “out of plane” This allows to build a very flexible “tactile” display that enables the creation of both “in plane” as well as “out of plane” tactile sensations by using the “out of plane” movement of the surface actuators. It also allows combined touch actuation and sensing from the same surface layer. Some capabilities of typical dielectric electroactive polymers are:

out-of-plane displacements >0.5 mm;

switching frequencies above 1000 Hz;

robust, “solid state” rubber layers;

typical actuator thickness 100 microns−2 mm;

combined sensing and actuating possible;

roll2roll manufacturability from simple, cheap bulk materials (polymers, carbon powder).

The actuators 120a, . . . 120k, . . . 120z can individually be activated by a controller 130. When being electrically activated, an actuator 120k of the array 120 makes an out-of-plane movement in z-direction. By such movements of individual actuators, a haptic feedback can be provided to a user touching the interaction surface S.

As indicated in FIG. 1, the activation of one or more actuators 120k at a particular location on the interaction surface S can for example be used to haptically indicate some value v₀on a (virtual) scale of values V ranging from a minimum (MIN) to a maximum (MAX). The indicated value v₀ may for example correspond to the presently set volume of a music player.

FIG. 2 shows neighboring actuators at the position of the aforementioned value v₀ at three consecutive points in time. Three actuators 120j, 120k, 1201 are activated one after the other in a repetitive manner. By shifting the point of activity in this way, a directional haptic sensation is generated in the skin of a user (not shown) touching the actuators which resembles the movement of an actual object in the direction indicated by a wriggled arrow. In the shown example, the directional haptic sensation points into the direction of reduced values V, while the position of the active actuators 120j, 120k, 1201 corresponds to the location of the presently set value v₀.

The operation scheme that is illustrated in FIG. 2 can be varied in many ways. The spatial period of the activation wave may for example extend over longer distances than the shown three actuators, or an out-of-plane elevation in the interaction surface S may be generated by the simultaneous activity of more than one actuator.

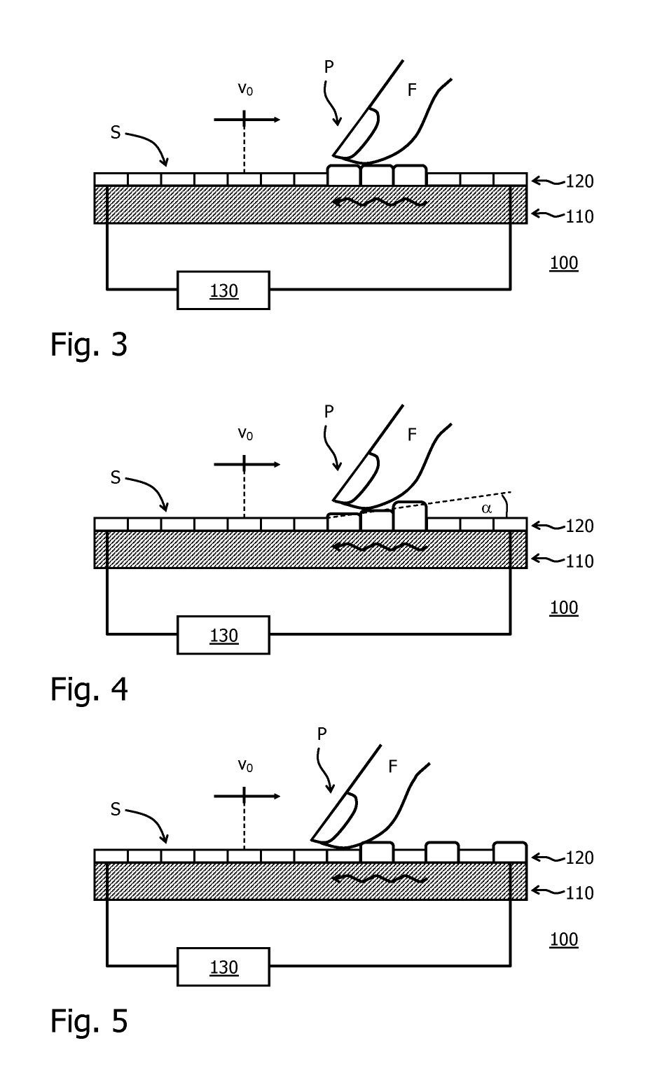

FIG. 3 illustrates another operation mode of the user interface 100. In contrast to the previous embodiments, this mode requires that the touch point P at which the finger F of a user touches the interaction surface S can be determined by the controller 130. Such a determination can be accomplished by any technology known from touch screens. Moreover, the EAP actuators of the array 120 themselves may be provided with sensing capabilities allowing to detect a pressure acting on them.

In the application of FIG. 3, only actuators in the region of the touch point P are activated because only they can actually contribute to a haptic feedback. In the shown example, these actuators are operated (e.g. in the manner shown in FIG. 2) to provide a directional haptic sensation that points towards a given location on the interaction surface S, namely to the (virtual) position of the set value v₀ as explained in FIG. 1.

FIG. 4 illustrates another principle by which directional haptic sensation can be conveyed at a touch point P (as shown) or anywhere else in the interaction surface S. In this embodiment, a graded activation of actuators implies that the activity/actuator height (in z-direction) for the involved actuators varies, creating a surface shape that includes a significant angle α in the surface. Even when there is no relative movement between a touching element F and the interaction surface S, this results in a directed guiding force, through the surface tangential force resulting from the slant.

FIG. 5 illustrates still another way to generate a directional haptic sensation at a touch point (as shown) or anywhere else in the interaction surface S. In this approach, a resistance or friction is created against the movement of a finger F touching the interaction surface S. By making said resistance anisotropic, a desired direction can be marked. In the shown example, the surface friction changes from high/rough to low/smooth at the touch point P when seen in the desired direction (wriggled arrow). Moving in the “right” direction will hence be easier for a finger F than moving in the “wrong” direction, as the latter movement is accompanied by a resistance.

It should be noted in this context that, in the schematic drawing of FIG. 5, a “high friction” is illustrated by a rough surface. When friction with the skin is considered, such a relation between surface roughness and friction (i.e. “higher roughness implies more friction”) is actually only valid for roughnesses of 90 microns and more. For many harder engineering materials and small roughnesses (< 10 microns), the effect is however reversed (“higher roughness implies less friction”) due to effects of contact area. Depending on the size of the actuators and/or the characteristic size of their activation patterns, increasing friction will therefore require either a high or a low surface roughness.

Moreover, an anisotropic friction may alternatively be realized by an appropriate (anisotropic) three-dimensional pattern on the interaction surface that causes different surface roughnesses in different directions. A pattern of lines or ridges may for example be generated on the interaction surface by a corresponding activation of actuators such that a direction perpendicular to the lines has a higher roughness (and friction effect) than a direction parallel to the lines.

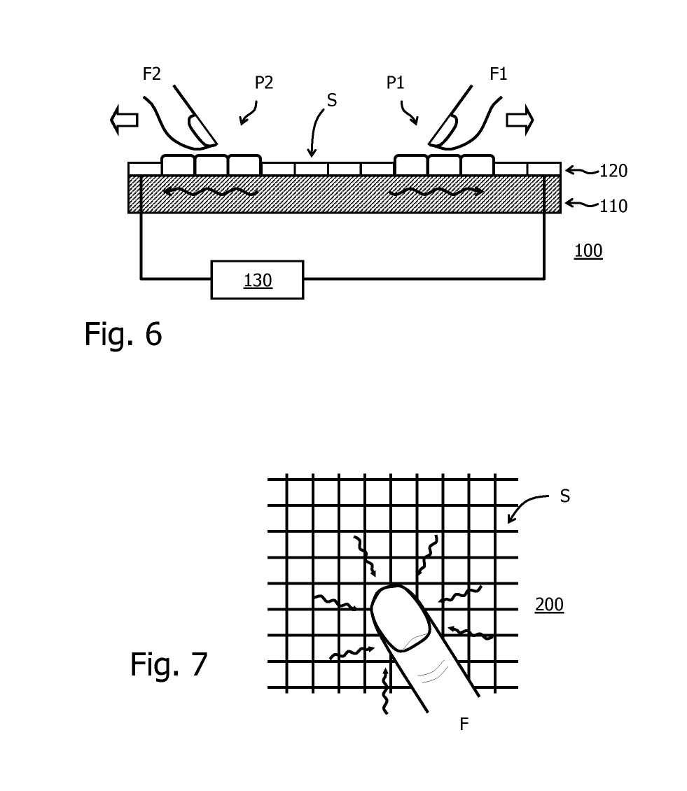

FIG. 6 shows still another operation mode of the user interface 100. Again, this mode requires that the touch points P1 and P2 of two (or more) user fingers F1, F2 can be determined by the controller 130. A multi-fingered input can for instance be used to intuitively zoom in our zoom out an image shown on the display 110 by stretching or compressing said image. FIG. 6 illustrates in this respect the particular example of a “zoom in” command for which two fingers F1 and F2 are moved away from each other in opposite directions. The directional haptic sensations that are generated at the touch points P1, P2 of the fingers correspond in this case preferably to be tactile sensation a real object would convey when being stretched. As indicated by the wriggled arrows, this directional haptic sensation is directed parallel to the movement of the fingers to simulate a synchronous movement of an underlying object.

FIG. 7 illustrates a top view onto the two-dimensional interaction surface S of a user interface 200. A directional haptic sensation is created that is directed radially inward with respect to the touch point of a finger F (or with respect to some other centre on the surface S). In this way shrinking movements of an underlying image can be simulated. When the direction of the haptic sensation is reversed, a sensation that is directed radially outward is generated, which may simulate the expansion of an underlying image.

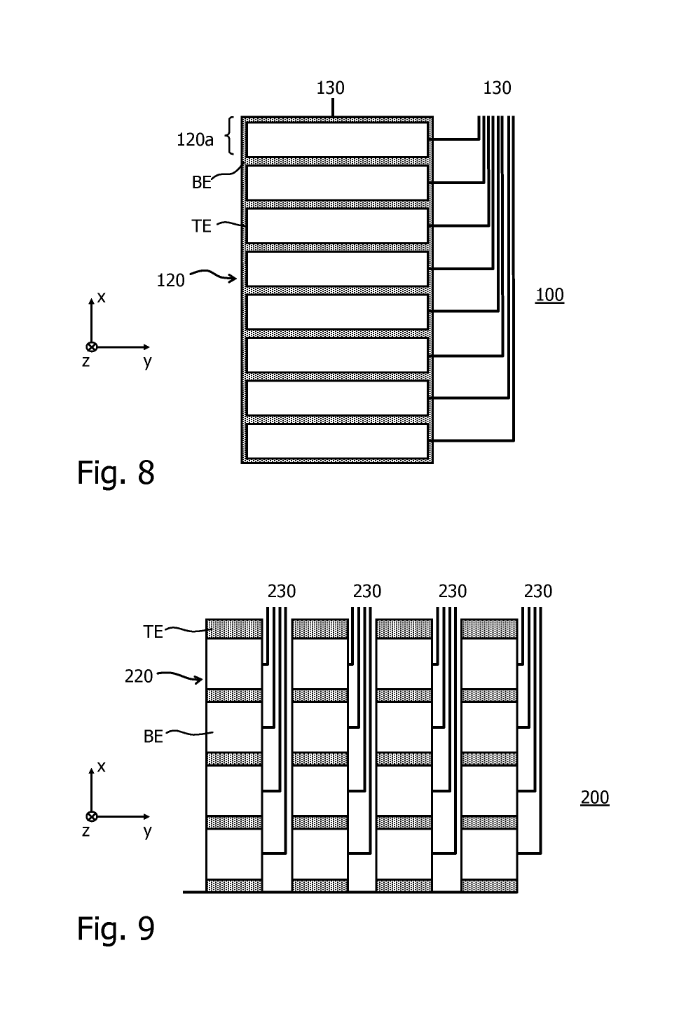

The basic functionality of the haptics user interface 100 described above is the creation of a dynamically adjustable surface profile in the form of a “small hill”, which propagates over the (2D) interaction surface like a wave. In one embodiment of the invention, such a propagating surface profile may be created using a one-dimensional array 120 of electrodes as shown in FIG. 8. The array 120 comprises a large top electrode TE that covers the whole array and that is typically set to ground potential during operation. Below said top electrode, a series of bottom electrodes BE is disposed that are individually connected to the controller 130. By setting a bottom electrode BE to a positive potential, the corresponding actuator can be activated to make on out-of-plane movement. In such a manner, a wave can be created which propagates across the interaction surface in positive or negative x-direction, as would for example be required for a reconfigurable UI with a dimmer bar (or a 1-D color temperature) functionality, where the dimmer bar may e.g. be given different lengths. Preferably the bottom electrodes BE have an elongated form, whereby the position of the wave along the dimmer bar can be more accurately defined.

In another, more flexible embodiment of the invention, the propagating surface profile is created using a two-dimensional array 220 of electrodes as shown in FIG. 9 in a top view onto the interaction surface S of the corresponding user interface 200. The array 220 comprises a plurality of parallel columns of bottom electrodes BE that are individually connected to a controller 230 and disposed below a top electrode TE. In such an array 220, a wave can be created which propagates across the surface in all directions, as would be required for a reconfigurable UI with a reconfigurable 2-D color wheel functionality. Preferably the bottom electrodes BE have a symmetric form (like a square, hexagon, circle etc.), whereby the position of the wave in any random direction can be more accurately defined.

The activated surface profile (i.e. the region with a tactile out-of-plane elevation) may be positioned on the interaction surface according to the expected vicinity of a finger (e.g. at the ends of the color/dimmer bar).

In another embodiment of the invention, the position of the activated surface profile is positioned not just at the expected vicinity of a finger, but is dynamically positioned at the actual position of a finger. The position of a finger may be established by a touch screen technology being used, and the position of the profile may be adjusted accordingly. This embodiment requires that the haptic material can deform at a relatively high rate.

In still a further, preferred, embodiment of the invention, the position of the activated surface profile is positioned not just at the measured position of a finger, but is dynamically positioned according to both the actual position and the detected direction of motion of the finger. The position of the finger may be established by the either the touch screen technology being used or directly from the dielectric actuator (which can also be used as a touch sensor), whilst the motion detection is established using a processing device which runs a motion direction algorithm based on the recorded positions of the finger in the time period prior to the present finger position. The position of the activated surface profile is adjusted according to both the position and direction of the finger. This embodiment is particularly useful in situations where the UI paradigm requires a two-dimensional movement of a finger, as in this case it is not a-priori clear where the surface profile should be created. This is particularly the case if multiple fingers require guidance to “stretch” a part of the UI image on the display, for example to “zoom in” to a more detailed part of color space, as described above.

The invention may for example be applied:

To provide a feedback of “stretching material” when zooming in on an area (e.g. multi-touch). This may be zooming in on the view of an image being displayed on a screen, or it may be zooming in on a specific parameter which is being controlled by a user interface element such as, for instance, a color wheel for lighting control or a slider. The user will experience an “in-plane” force feedback that suggests that she or he is really physically stretching some material.

To generate reconfigurable user interfaces on display based UI devices for future multi-luminary lighting systems, where the lighting configuration is expandable.

To set light intensities and colors by dimmer bars and color wheels, respectively.

To generate a 2D “dimmer bar” as alternative to a color wheel for e.g. color selection for lighting systems.

To provide stretching feedback during selection of a particular element or application from a (main) menu. This provides the tactile sensation to a user that she or he is going one level deeper into the menu structure.

Moreover, the invention may advantageously be applied to user interface elements on touch screens, to touch pads, or to other touch-sensitive input methods such as touch wheels.

Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, reference signs in the claims shall not be construed as limiting their scope.

1. A user interface, comprising:
a) a touchable interaction surface (S);
b) an array of actuators that are disposed in the interaction surface for providing haptic feedback;
c) a controller for activating actuators in a coordinated manner such that they provide a directional haptic sensation;
wherein the directional haptic sensation is generated by a graded activation of actuators with an activation degree that changes monotonously in one direction,
and/or wherein actuators are activated to change the friction between an object touching the interaction surface (S) and said surface.

2. A method for providing haptic feedback to a user touching an interaction surface (S) with an array of actuators, said method comprising the coordinated activation of actuators to generate a directional haptic sensation, wherein the directional haptic sensation is generated by a graded activation of actuators with
an activation degree that changes monotonously in one direction,
and/or wherein actuators are activated to change the friction between an object touching the interaction surface (S) and said surface.

3. The user interface according to claim 1, characterized in that the interaction surface (S) is adapted to determine the position and/or a movement of at least one touch point (P, P1, P2) at which it is touched by a user.

4. The user interface or the method according to claim 3, characterized in that only actuators in a region that depends on the position and/or a movement of the at least one touch point (P, P1, P2) are activated to provide a directional haptic sensation.

5. The user interface or the method according to claim 3, characterized in that the direction of the directional haptic sensation depends on the position and/or a movement of the at least one touch point (P, P1, P2).

6. A user interface, particularly according to claim 1, comprising:
a) a touchable interaction surface (S);
b) an array of actuators that, are disposed in the interaction surface for providing haptic feedback;
c) a controller for activating actuators in a coordinated manner such that they provide a directional haptic sensation;
wherein the directional haptic sensation is directed to a given location on the interaction surface (S), said location corresponding to the position and/or a movement direction of a control element.

7. The user interface according to claim 1, characterized in that the directional haptic sensation is directed radially inwards or outwards with respect to a centre.

8. The user interface according to claim 1, characterized in that the interaction surface (S) is located above an image display.

9. The user interface or the method according to claim 8, characterized in that the directional haptic sensation is correlated to an image and/or an image sequence shown on the display.

10. A user interface, particularly according to claim 1, comprising:
a) a touchable interaction surface (S);
b) an array of actuators that are disposed in the interaction surface for providing haptic feedback;
c) a controller for activating actuators in a coordinated manner such that they provide a directional haptic sensation;
d) an image display that is located below the interaction surface (S);
wherein the directional haptic sensation is correlated to an expansion or contraction of a displayed image.

11. The user interface according to claim 1, characterized in that the actuators comprise an electroactive material, particularly an electroactive polymer.

12. The user interface according to claim 1, characterized in that the directional haptic sensation is generated by a sequential activation of neighboring actuators.

13. The user interface cording to claim 1, characterized in that the directional haptic sensation is generated by a graded activation of actuators, particularly by an activation degree that changes monotonously in one direction.

14. The user interface according to claim 1, characterized in that actuators are activated to change the friction between an object touching the interaction surface (S) and said surface.

15. An apparatus comprising a user interface according to claim 1, particularly a mobile phone, a light controller, a remote-control, or a game console.
